(19) United States
(12) Patent Application Publication
(10) Pub. No.: US 2010/0023495 A1
(43) Pub. Date: Jan. 28, 2010

(54) SYSTEM FOR SUGGESTING KEYWORDS BASED ON MOBILE SPECIFIC ATTRIBUTES

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/963,154

(22) Filed: Dec. 21, 2007

(51) Int. Cl. G06F 7/10; G06F 17/30

(52) U.S. Cl. 707/4; 707/E17.07; 707/E17.018

(57) ABSTRACT

A system is described for suggesting keywords to users based on mobile specific attributes. The system may include a processor, a memory and an interface being operatively connected. The memory may store a search query. The processor may be operative to communicate with a user on a mobile device. The mobile device may be associated with a mobile carrier. The processor may receive a search query from the user on the mobile device. The processor may identify a mobile specific attribute of the user. The processor may generate a suggested query related to the mobile specific attribute of the user and the search query. The processor may provide the suggested query to the user.

### TECHNICAL FIELD

The present description relates generally to a system and method, generally referred to as a system, for suggesting keywords based on mobile specific attributes, and more particularly, but not exclusively, to suggesting keywords to users and advertisers that relate to attributes unique to mobile systems.

### BACKGROUND

The mobile phone may be increasingly important as an information and content access device. Currently there may be twice as many mobile communication devices as personal computers. Mobile operators may be increasingly looking to high value data services as a way to overcome the continuing voice average revenue per user decline. Billions of dollars may be being spent globally on wireless licenses with billions more in investments in the pipeline for development of infrastructure and services by wireless service and content providers. Carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

Mobile advertising may play an important role in generating revenue in the mobile world. The mobile advertising market may grow as users become more comfortable with using their mobile phones as web access devices. The mobile phone may present advertisers with access to consumers everywhere the consumers take their mobile phones. However, the traditional model of targeting advertisements to queries may be ineffective when targeting a user on a mobile device. Users may interact with a mobile device differently than they might interact with a computer. Semantics and user intent may differ on a mobile device and on a computer. There may be constraints relative to using the mobile device that may effect how a user interacts with the mobile device, such as a mobile device may have a limited amount of screen space. The screen of a mobile device may only allow for one advertisement to be displayed to a user at a time, greatly increasing the need for accurately targeting advertisements to keywords.

### SUMMARY

A system is disclosed for suggesting keywords based on mobile specific attributes. The system may include a processor, a memory and an interface. The memory may store a search query. The interface may be operatively connected to the memory and the processor and may be operative to communicate with a user on a mobile device. The mobile device may be associated with a mobile carrier. The processor may be operatively connected to the memory and the interface. The processor may receive a search query from the user via the interface. The processor may identify a mobile specific attribute of the user. The processor may generate a suggested query related to the mobile specific attribute of the user and the search query. The processor may provide the suggested query to the user.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for suggesting keywords based on mobile specific attributes.

FIG. 2 is a block diagram of a simplified view of a network environment implementing the system of FIG. 1 or other systems for suggesting keywords based on mobile specific attributes.

FIG. 3 is a block diagram of an implementation of the system of FIG. 1 or other systems for suggesting keywords based on mobile specific attributes.

FIG. 4 is a flowchart illustrating operations of suggesting queries to users in the system of FIG. 1, or other systems for suggesting keywords based on mobile specific attributes.

FIG. 5 is a flowchart illustrating operations of suggesting queries to revenue generators in the system of FIG. 1, or other systems for suggesting keywords based on mobile specific attributes.

FIG. 6 is an illustration of a mobile device displaying queries suggested to a user in the system of FIG. 1 or other systems for suggesting keywords based on mobile specific attributes.

FIG. 7 is an illustration a general computer system that may be used in a system for suggesting keywords based on mobile specific attributes.

### DETAILED DESCRIPTION

The present description relates generally to a system and method, generally referred to as a system, for suggesting keywords based on mobile specific attributes, and more particularly, but not exclusively, to suggesting queries to users and advertisers that relate to attributes unique to mobile devices.

The system may enable an advertiser to target advertisements to queries which relate to attributes of the advertiser's mobile presence or to the mobile carrier the advertiser is advertising on. A query may be a set words a user may search for, such as one or more keywords. Advertisers may be unaware of trends in the mobile web and in mobile devices and may be unaware of queries which may be valuable to their advertising campaign. The system may suggest queries to the advertisers which are related to a query identified by the advertiser and are related to mobile specific attributes of the advertiser and/or the mobile carrier.

The system may assist a user in finding mobile information relevant to a search query and the user's mobile specific attributes, such as the user's use of the mobile environment. A user may search for a query and may be unaware of mobile specific items relating to the search query. The system may suggest mobile specific queries that relate to the search query. The system may suggest queries which are related to the search query and are related to the mobile usage of the user, such as the mobile interests of the user, the mobile data plan of the user, the amount of time the user surfs the mobile web, or generally any data that may be specific to the mobile environment.

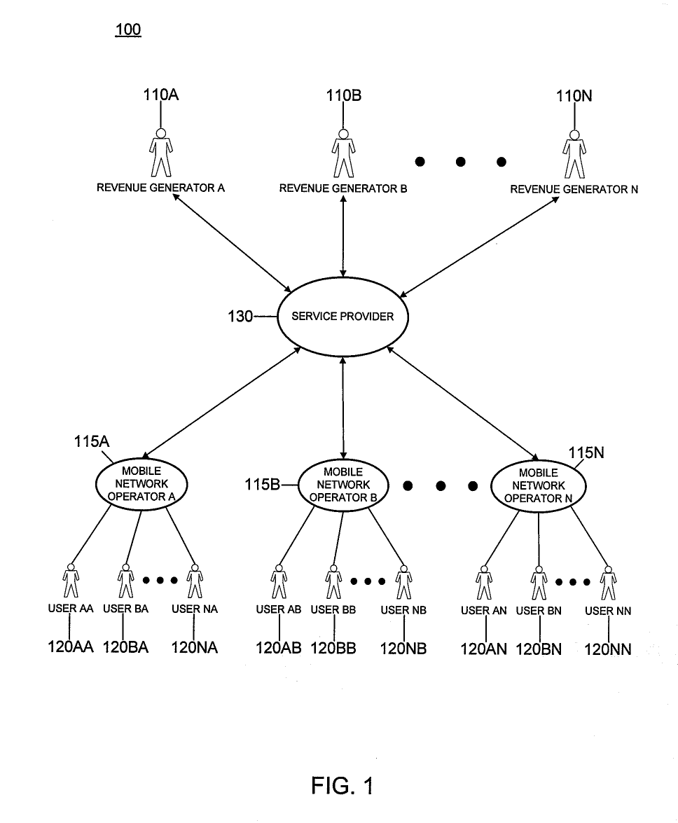

FIG. 1 provides a general overview of a system 100 for suggesting keywords based on mobile specific attributes. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal or an advertising service provider, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The revenue generators 110A-N may pay the service provider 130 to serve, or display, advertisements of their goods or services, such as on-line or mobile advertisements, to the users 120AA-NN, such as over mobile messaging, mobile web, the Internet, or generally any venue for displaying advertisements. The advertisements may include sponsored listings, banners ads, popup advertisements, mobile messages, or generally any way of attracting the users 120AA-NN to the web site or mobile site of the revenue generators 110A-N. The users 120AA-NN may utilize the services of the service provider 130 through web applications, mobile applications or standalone applications.

The service provider 130 may maintain a mobile portal and/or a web portal, such as a search site, where the service provider 130 may display advertisements of the revenue generators 110A-N to the users 120AA-NN. The users 120AA-NN may use mobile devices to interact with the search site provided by the service provider 130 to search for information on the mobile web. One of the users 120AA-NN, such as the user AA 120AA, may communicate a search query to the service provider 130 relating to the information they are searching for. The service provider 130 may provide data related to the query to the users 120AA-NN and may provide suggested queries which may be of interest to the users 120AA-NN. Alternatively or in addition the service provider 130 may provide advertisements to a third party server, such as a third party search portal. The third party server may submit an advertisement request to the service provider 130 through an interface such as an application programming interface (“API”). The service provider 130 may use the date submitted with the request to retrieve and return relevant advertisements to the third party server.

The suggested queries may relate to the query searched for by the user AA 120AA, as well as mobile specific attributes of the user AA 120AA and/or mobile specific attributes of the mobile carrier providing mobile service to the user AA 120AA. Mobile specific attributes of a user AA 120AA may include the amount of time the user AA 120AA uses their mobile device to access the mobile web each month, the amount of time the user AA 120AA spends talking on their mobile device each month, the cost of the mobile service plan of the user AA 120AA, the features of the mobile service plan of the user AA 120AA, the mobile web sites visited by the user AA 120AA, the amount of data the user AA 120AA receives per month, the purchase history of the user AA 120AA of mobile specific items, such as ring tones, the number of text messages sent and/or received by the user AA 120AA per month, the browsing history of mobile specific sites of the user AA 120AA, the capabilities of the mobile device of the user AA 120AA, or generally any mobile specific data related to the mobile interactions of the user AA 120AA. Mobile specific attributes of a mobile carrier may include the mobile services provided by the mobile carrier, the number of users 120AA-NN who subscribe to each of the mobile services, the location of cell towers of the mobile carrier, the mobile devices supported by the mobile carrier, the mobile technologies supported by the mobile carrier, or generally any mobile specific data related to a mobile carrier.

For example, if the user AA 120AA searches for Britney Spears on their mobile device, and the user AA 120AA has a mobile purchase history of purchasing mobile ring tones, the system 100 may suggest the query “ringtones,” or “Britney Spears ringtones.” If the user AA 120AA searches for “video conferencing” and a mobile feature the user AA 120AA subscribes to is video calling, the system may suggest the query “mobile video calls.” The service provider 130 may maintain a database which may map common search terms to one or more unique mobile attributes. An administrative user may enter the data into the database or the service provider 130 may generate the database by analyzing mobile search queries and the links clicked on by the users 120AA-NN after searching for the mobile search queries.

Alternatively or in addition, the service provider 130 may utilize an existing query suggestion system. An existing query suggestion system may perform an analysis on the query of a user AA 120AA, or a query determined from, or related to, the mobile specific attributes of the user AA 120AA, the mobile carrier, or one of the revenue generators 110A-N, to find additional queries that may relate to the query of the user A 120A, or the query determined from the mobile attributes. Some examples of query suggestion systems may include King Kong, SPM, MOD, Units, or query suggestions derived from a network of advertisers and users.

Alternatively or in addition, queries received by the service provider 130 may be matched to additional queries related to mobile specific attributes through existing query suggestion systems of the service provider 130. More detail regarding the aspects of query suggestions systems, as well as their structure, function and operation, can be found in commonly owned U.S. patent application Ser. No. 10/625,082, filed on Jul. 22, 2003, entitled, “TERM-BASED CONCEPT MARKET”; U.S. patent application Ser. No. 11/295,166, filed on Dec. 5, 2005, entitled “SYSTEMS AND METHODS FOR MANAGING AND USING MULTIPLE CONCEPT NETWORKS FOR ASSISTED SEARCH PROCESSING”; U.S. patent application Ser. No. 10/797,586, filed on Mar. 9, 2004, entitled “VECTOR ANALYSIS OF HISTOGRAMS FOR UNITS OF A CONCEPT NETWORK IN SEARCH QUERY PROCESSING”; U.S. patent application Ser. No. 10/797,614, filed on Mar. 9, 2004, entitled “SYSTEMS AND METHODS FOR SEARCH PROCESSING USING SUPERUNITS”; U.S. Pat. No. 7,051,023, filed on Nov. 12, 2003, entitled “SYSTEMS AND METHODS FOR GENERATING CONCEPT UNITS FROM SEARCH QUERIES,” and U.S. Pat. No. 6,876,997, filed on May 22, 2000, entitled “METHOD AND APPARATUS FOR IDENTIFYING RELATED SEARCHES IN A DATABASE SEARCH SYSTEM”; U.S. patent application Ser. No. 10/797,614, filed on Mar. 9, 2004, entitled “SYSTEMS AND METHODS FOR SEARCH PROCESSING USING SUPERUNITS”, all of which are hereby incorporated herein by reference in their entirety. The systems and methods herein associated with query suggestion systems analysis may be practiced in combination with methods and systems described in the above-identified patent applications incorporated by reference.

Alternatively or in addition the service provider 130 may be an advertising services provider. Third party entities, such as the MNOs 115A-N may request advertisements from the service provider 130 through an API. The service provider 130 may return advertisements of the revenue generators 110A-N to the MNOs 115A-N relating to data submitted in the advertisement request. The MNOs 115A-N may then display the advertisements to the users 120AA-NN. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply the API to the MNOs 115A-N enabling the MNOs 115A-N to request advertisements from the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The amount the revenue generators 110A-N may pay the service provider 130 may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may be consumers of goods or services who may be searching for a business, such as the business of one of the revenue generators 110A-N. The users 120AA-NN may be searching for the internet presence of one of the revenue generators 110A-N, or the real world, or brick and mortar, presence of one of the revenue generators 110A-N. Alternatively or in addition the users 120AA-NN may be machines or other servers, such as a third party server. The users 120AA-NN may need a user identifier or identification (“user ID”) to access the services of the service provider 130. In order to obtain a user ID the users 120AA-NN may need to supply information describing themselves to the service provider 130, such as gender, and/or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130. The service provider 130 may also collect mobile specific attributes from the users 120AA-NN when the users 120AA-NN are logged in to the services of the service provider 130. The service provider 130 may also use cookies, such as a browser cookie, to collect user behavior data of users 120AA-NN who are not logged in or who are not otherwise identifiable.

The service provider 130 may serve advertisements relevant to collected user behavior data to the users 120AA-NN, via mobile messages, mobile web pages, or mobile applications. For example, if a user AA 120AA performed searches for sports topics, subscribed for sports alerts, or viewed sports related media or articles, the service provider server 130 may serve a sports related ad to the user AA 120AA with the alert. The revenue generators 110A-N may identify categories to associate their advertisements with, such as sports. Alternatively or in addition, the service provider server 130 may perform content matching on the advertisements of the revenue generators 110A-N and identified interests of the user AA 120AA, such as sports. The service provider 130 may serve advertisements directly to the users 120AA-NN, or the MNOs 115A-N, and/or other third party servers, may request advertisements from the service provider 130 to display to the users 120AA-NN.

In the system 100, the revenue generators 110A-N may interact with the service provider 130, such as via a web application. The revenue generators 110A-N may send information, such as billing, website or mobile site, queries, and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. Alternatively or in addition the revenue generators 110A-N may interact with the service provider 130 via a mobile device.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements to users 120AA-NN over mobile devices.

A revenue generator A 110A who is a mobile advertiser may maintain one or more accounts with the service provider 130. For each account the revenue generator A 110A may maintain one or more campaigns. For each campaign the revenue generator A 110A may maintain one or more listings. A listing may include one or more queries, or a category, and one or more mobile message listings. Each listing may include an advertisement title, an advertisement description, a bid amount and a mobile site URL, if any. A listing may represent an association between one or more queries, or a category, a mobile advertisement, and a mobile carrier. A campaign may be a group of related listings.

When the revenue generator A 110A identifies one or more queries to associate with a mobile carrier and a campaign, or a listing, the service provider 130 may suggest one or more additional queries related to the mobile specific attributes of the revenue generator A 110A and/or the mobile carrier. Mobile specific attributes of a revenue generator A 110A may include whether the revenue generator A 110A has a mobile presence, the extent of the mobile presence of the revenue generator A 110A, the content of the mobile page of the revenue generator A 110A, any mobile specific items or services offered by the revenue generator A 110A, or generally any mobile specific attribute that may relate to revenue generators 110A-N.

If the revenue generator A 110A does not have a mobile site URL for the MNO A 115A, the revenue generator A 110A may still bid on a query for the MNO A 115A. In this case, the service provider 130 may dynamically create a “WAP ad.” The “WAP ad” may be an offer landing page containing the phone number of the advertiser and/or the logo of the advertiser. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The queries may represent one or more keywords that the revenue generator A 110A wishes to associate with their advertisement. If the queries appear in a mobile message, a mobile search request, or the content of a mobile page, the advertisement of the revenue generator A 110A may be displayed to the user AA 120AA. The advertisement title may represent the data the revenue generator A 110A wishes to be displayed to a user AA 120AA. Alternatively or in addition, the advertisement description may represent the data the revenue generator A 110A wishes to be displayed to a user AA 120AA when the user AA 120AA receives a mobile message containing the query. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA.

There may be some instances where multiple revenue generators 110A-N may have bid on the same queries for one of the MNOS 115A-N. The service provider 130 may serve to the users 120AA-NN the advertisements that the users 120AA-NN may be most likely to click on. For example, the service provider 130 may include a relevancy assessment to determine the relevancy of the multiple mobile advertisements to the queries. The more relevant a mobile advertisement may be to the query the more likely it may be that the user AA 120AA may click on the advertisement. Alternatively or in addition, queries received by the service provider 130 may be matched to additional queries related to mobile specific attributes through the existing query suggestion systems of the service provider 130.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

Furthermore, the service provider 130 may generate reports based on the data collected from the users 120AA-NN and communicate the reports to the revenue generators 110A-N to assist the revenue generators 110A-N in measuring the effectiveness of their mobile advertising campaigns. The reports may indicate the number of times the users 120AA-NN viewed a mobile advertisement of the revenue generators 110A-N, the number of times a mobile advertisement of the revenue generators 110A-N was clicked on by the users 120AA-NN, or generally any information useful to the revenue generators 110A-N. The reports may further include mobile specific attributes of the users 120AA-NN, such as a break down of the percentage of users 120AA-NN who share a particular mobile specific attribute.

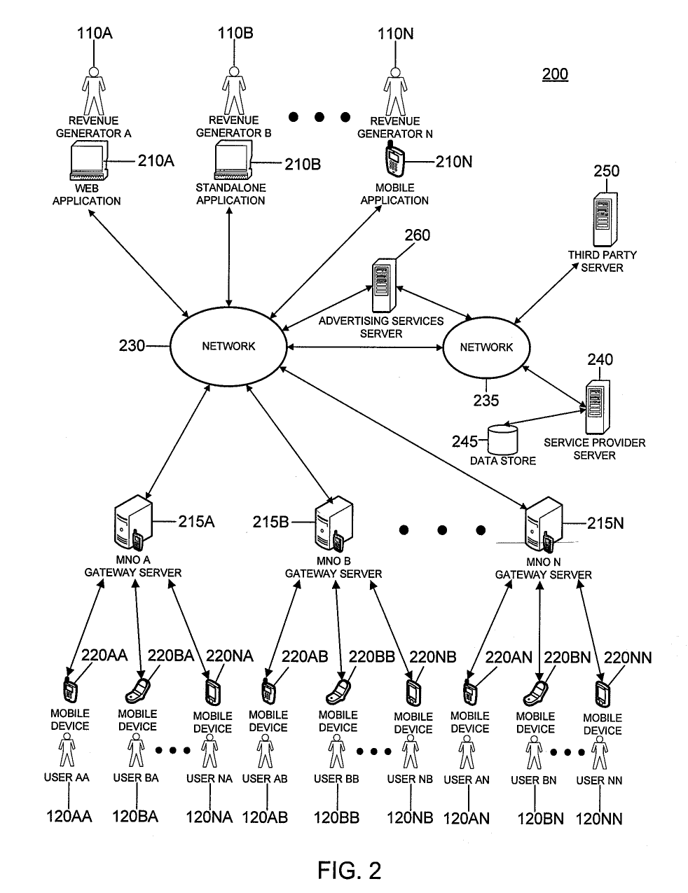

FIG. 2 provides a simplified view of a network environment implementing a system 200 for suggesting keywords based on mobile specific attributes. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN. The system 200 may also include one or more MNO gateway servers 215A-N, a network 230, a network 235, a data store 245, the service provider server 240, a third party server 250, and an advertising services server 260.

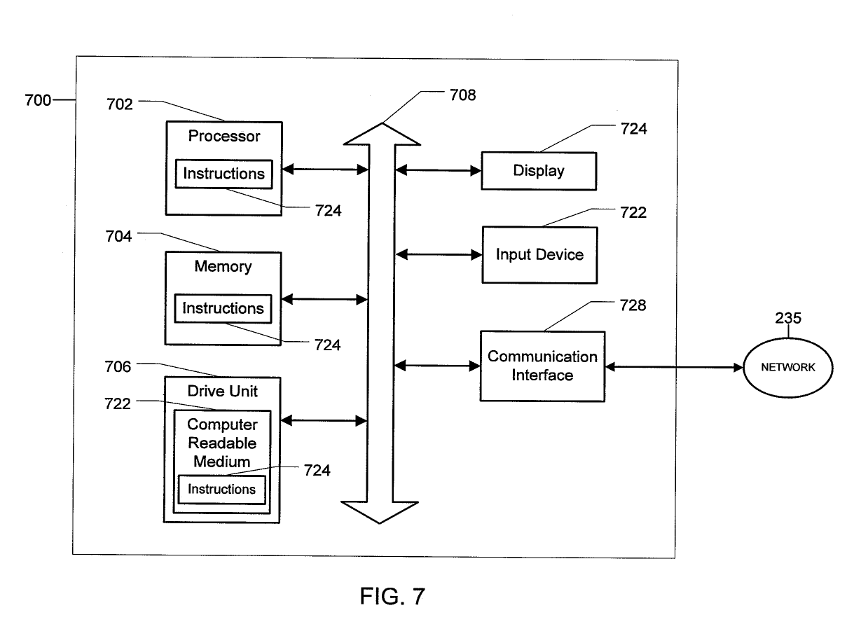

Some or all of the advertisement services server 260, service provider server 240, and third-party server 250 may be in communication with each other by way of network 235 and may be the system or components described below in FIG. 7. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The data store 245 may be operative to store data, such as data relating to interactions with the users 120AA-NN. The data store 245 may also store data describing the mobile attributes of the MNOs 115A-N, the users 120AA-NN and the revenue generators 110A-N. The system 100 may maintain and update data related to the mobile attributes of the MNOs 115A-N, the users 120AA-NN and the revenue generators 110A-N. There may be a server or a set of servers dedicated to tracking and updating the mobile attributes of the users 120AA-NN, the MNOs 115A-N and the revenue generators 110A-N. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with the revenue generator B 110B. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The MNOs 115A-N may utilize various components to provide these services to the users 120AA-NN, such as network switching systems (“NSS”), mobile switching centers (“MSC”), mobile switching center servers (“MSC-S”), home location registers (“HLR”), authentication centers (“AUC”), short message service centers (“SMSC”), signal transfer points (“STP”), message service centers (“MSC”), or generally any component that may be utilized to provide the mobile services. The MNOs 115A-N may interface with one or more external short messaging entities (ESME), such as the third party server 250, which may connect to the MNOs 115A-N to send and/or receive mobile messages to the users 120AA-NN. The ESMEs may provide voicemail, web, email, or other services to the users 120AA-NN of the MNOs 115A-N.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve web pages and/or mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be an ESME server. The advertising services server 260 may provide a platform for the inclusion of advertisements in pages, such as web pages or mobile pages. The advertisement services server 260 may be used for providing mobile advertisements that may be displayed to the users 120AA-NN. The third party server 250 may request advertisements from the service provider server 240 or the advertisement services server 260 via an API.

The service provider server 240, the third party server 250 and the advertising services server 260 may be one or more computing devices of various kinds, such as the computing device in FIG. 7. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server 260 may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

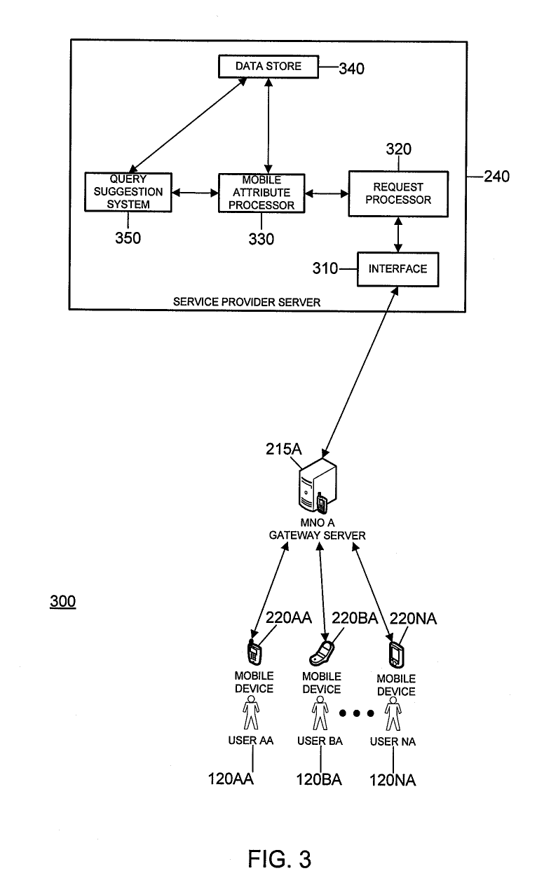

FIG. 3 illustrates a block diagram of an implementation of the system of FIG. 1 or other systems for suggesting keywords based on mobile specific attributes. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the MNO A gateway server 215A, the mobile devices 220AA-NA, and the users 120AA-NA. The service provider server 240 may include an interface 310, a request processor 320, a mobile attribute processor 330, a data store 340, and a query suggestion system 350. The interface 310 may enable the MNO A gateway server 215A to communicate with the service provider server 240. The request processor 320 may process a request from the mobile devices 220AA-NA and/or the MNO A gateway server 215A to identify the query searched for and to identify the originating MNO A gateway server 215A and/or the mobile devices 220AA-NA. The mobile attribute processor 330 may process the identifying data to retrieve mobile specific attribute data relating to the MNOS 115A-N, the users 120AA-NA, and/or the revenue generators 110A-N. The mobile attribute processor 330 may further retrieve queries from the data store 340 related to the query searched for and the mobile specific attributes. The data store 340 may store mobile specific attribute data relating to the MNOS 115A-N, the users 120AA-NA, and/or the revenue generators 110A-N. Alternatively or in addition the data store 240 may store queries and advertisements. The query suggestion system 350 may be operative to receive mobile specific attributes and a query from the mobile attribute processor 330 and retrieve one or more queries relating to the mobile specific attributes and the query.

In operation one of the users 120AA-NA, such as the user AA 120AA, may search for a query via the mobile device 220AA. The mobile device 220AA may communicate the query to the service provider server 240 via the MNO A gateway server 215A. The interface 310 may receive the request and communicate the request to the request processor 320. The request processor 320 may process the request from the MNO A gateway server 215A to format the data from the request into a standardized form used by the mobile attribute processor 330. The processing of the data may include parsing the demographic information of the user AA 120AA, and determining the carrier the user AA 120AA is communicating though. The request processor 320 may then communicate the processed data to the mobile attribute processor 330.

The mobile attribute processor 330 may retrieve mobile attribute data for the user AA 120AA from the data store 340. Alternatively or in addition the mobile attribute processor 330 may retrieve mobile attribute data for the MNO A 115A carrier or one of the revenue generators 110A-N. The mobile attribute processor 330 may communicate the mobile specific attributes and the query to the query suggestion system 350. The query suggestion system 350 may be an existing query suggestion system. Alternatively or in addition the query suggestion system 350 may be a system that generates queries which are combinations of the mobile attributes and the query. Alternatively or in addition the query suggestion system 350 may access a database which maps common mobile search queries and common mobile specific attributes to suggested queries. The query suggestion system 350 may retrieve a suggested query mapped to the mobile specific attributes and the search query. The query suggestion system 350 may communicate the suggested queries to the user AA 120AA through the interface 310 and the MNO A gateway server 215A.

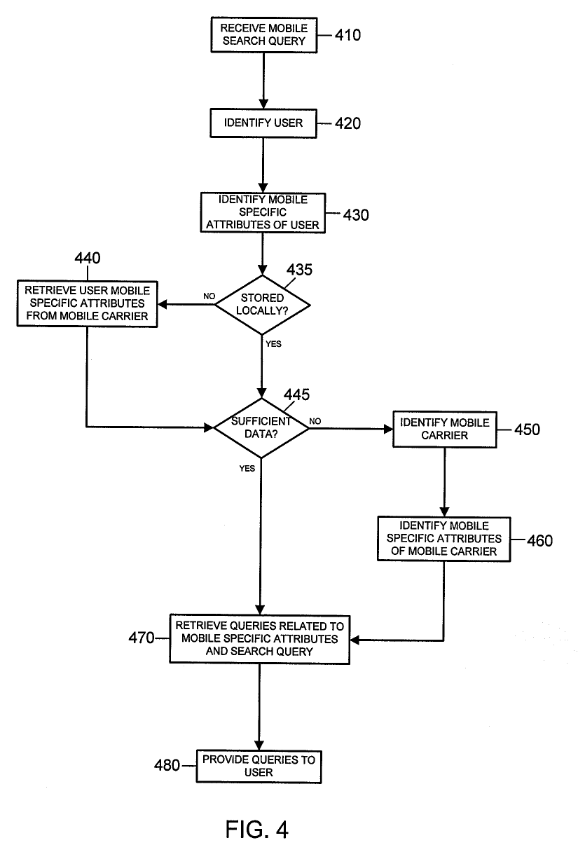

FIG. 4 is a flowchart illustrating operations of suggesting queries to users in the system of FIG. 1, or other systems for suggesting keywords based on mobile specific attributes. At block 410 the service provider server 240 may receive a search query from one of the users 120AA-NN. At block 420 the service provider server 420 may identify the user originating the search request, such as the user AA 120AA. The service provider server 420 may identify the user AA 120AA by matching the registration information of the user AA 120AA to the mobile device 220AA of the user AA 120AA. Alternatively or in addition the service provider server 240 may request the identify of the user AA 120AA from the MNO A 115A. Alternatively or in addition the user AA 120AA may have submitted login information to the service provider server 240. At block 430 the service provider 240 may identify mobile specific attributes related to the user AA 120AA. The mobile specific attributes of a user AA 120AA may include the amount of time the user AA 120AA uses their mobile device to access the mobile web each month, the amount of time the user AA 120AA spends talking on their mobile device each month, the cost of the mobile service plan of the user AA 120AA, the features of the mobile service plan of the user AA 120AA, the mobile web sites visited by the user AA 120AA, the amount of data the user AA 120AA receives per month, the purchase history of the user AA 120AA of mobile specific items, such as ring tones, the number of text messages sent and/or received by the user AA 120AA per month, the browsing history of mobile specific sites of the user AA 120AA, the capabilities of the mobile device of the user AA 120AA,or generally any mobile specific data related to the mobile interactions of the user AA 120AA.

At block 435 the service provider server 240 may determine whether any of the mobile specific attributes of the user AA 120AA are stored locally in the data store 245, or generally in any data store in communication with the service provider server 240. If there are no mobile specific attributes of the user AA 120AA stored locally the system may move to block 440. At block 440 the system 100 may request mobile specific attributes of the user AA 120AA from the MNO A 115A, such as the mobile plan of the user AA 120AA and any other mobile specific attributes of the user AA 120AA known to the MNO A 115A. At block 445 the system 100 may determine whether the mobile specific attributes of the user AA 120AA contains a sufficient quantity of data to retrieve useful query suggestions, such as if the quantity of mobile specific attributes of the user AA 120AA exceeds a threshold. Alternatively or in addition the system 100 may determine that there is not sufficient data if the search query and the mobile specific attributes are submitted to the query suggestion system 350 and the query suggestion system 350 is unable to return any query suggestions.

If at block 445 the system 100 determines that the quantity of mobile specific attributes of the user AA 120AA is not sufficient to retrieve useful query suggestions the system 100 may move to block 450. At block 450 the service provider server 240 may identify the MNO A 115A. The MNO A 115A may be identifiable by the internet protocol (“IP”) address associated with requests from the mobile devices 220AA-NA communicating through the MNO A 115A. At block 460 the service provider server 240 may identify the mobile specific attributes of the MNO A 115A. The mobile specific attributes of the MNO A 115A may include the mobile services provided by the MNO A 115A, the number of users 120AA-NA who subscribe to each of the mobile services, the location of cell towers of the MNO A 115A, the mobile devices 220AA-NA supported by the MNO A 115A, the mobile technologies supported by the MNO A 115A, or generally any mobile specific data related to a mobile carrier. The service provider server 240 may track and store mobile specific attribute data of the MNO A 115A, such as by requiring the MNO A 115A to submit mobile specific information in order to user the services provided by the service provider 130. Alternatively or in addition the service provider server 240 may request the mobile specific attributes directly from the MNO A gateway server 215A. The system 100 may then move to block 470.

If at block 445 the service provider server 240 determines that the quantity of mobile specific attributes of the user AA 120AA is sufficient for generating useful query suggestions, the system 100 may move to block 470. At block 470 the service provider server 240 may retrieve queries related to the query searched for by the user and the mobile specific attributes of the user AA 120AA or the MNO A 115A. For example, the service provider server 240 may communicate the mobile specific attributes and the query to a query suggestion system 350, and the query suggestion system 350 may return one or more related queries. Alternatively or in addition the service provider server 240 may combine the query searched for with one or more of the mobile specific attributes to create query suggestions. For example if the user AA 120AA searched for the query “Britney Spears,” and a mobile specific attribute of the user AA 120AA is that the user AA 120AA subscribes to a ringback tones service provided by the MNO A 115A, the service provider server 240 may suggest the query “Britney Spears ringback tones.” At block 480 the service provider server 240 may provide the suggested queries to the user AA 120AA, such as by causing the suggested queries to be displayed on the mobile device 220AA of the user AA 120AA. The user AA 120AA may be able to click on the suggested queries to bring up a new set of mobile search results relating to the suggested query.

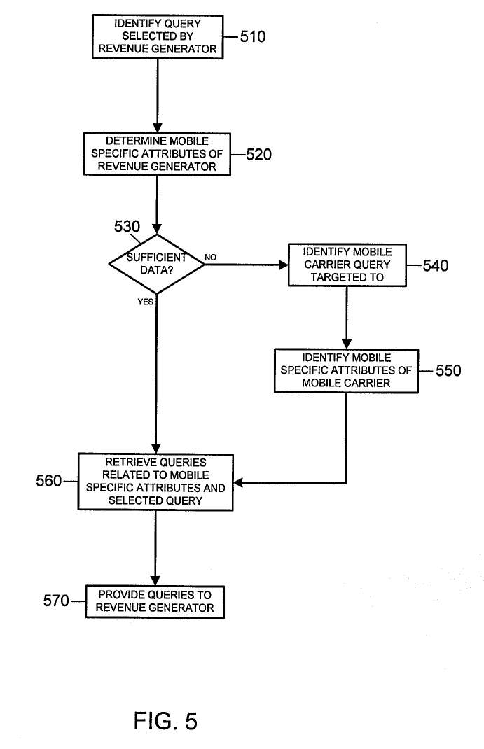

FIG. 5 is a flowchart illustrating operations of suggesting queries to revenue generators in the system of FIG. 1, or other systems for suggesting keywords based on mobile specific attributes. At block 510 the service provider server 240 may identify a query selected by one of the revenue generators 110A-N, such as the revenue generator A 110A. The revenue generator A 110A may select a query when associating search queries with listings and/or campaigns. At block 520 the service provider server 240 may determine the mobile specific attributes of the revenue generator A 110A. The mobile specific attributes of the revenue generator A 110A may include whether the revenue generator A 110A has a mobile presence, the extent of the mobile presence of the revenue generator A 110A, the content of the mobile page of the revenue generator A 110A, any mobile specific items or services offered by the revenue generator A 110A, or generally any mobile specific attribute that may relate to revenue generators 110A-N. The service provider server 240 may track and store mobile specific attributes of the revenue generator A 115A in the data store 245. Alternatively or in addition the service provider 130 may require the revenue generators 110A-N to provide mobile specific attributes in order to use the services of the service provider 130, such as mobile advertising services. Alternatively or in addition the service provider server 240 may request mobile specific attributes from the revenue generator A 110A.

At block 530 the service provider server 240 may determine whether there is a sufficient quantity of mobile specific attributes of the revenue generator A 110A to generate useful query suggestions, such as if the number of mobile specific attributes of the revenue generator A 110A exceeds a threshold. Alternatively or in addition the system 100 may determine that there is not a sufficient quantity of mobile specific attributes if the mobile specific attributes and the selected keyword are submitted to the query suggestions system 350 and the query suggestion system 350 is unable to return any query suggestions.

If at block 530 the service provider server 240 determines that there is not a sufficient quantity of data in the mobile specific attributes of the revenue generator A 110A to generate useful query suggestions the system 100 may move to block 540. At block 540 the service provider server 240 may identify the mobile carrier the revenue generator A 110A is targeting the selected query to, such as the MNO A 115A. At block 550 the system 100 may identify the mobile specific attributes of the MNO A 115A. The mobile specific attributes of the MNO A 115A may include the mobile services provided by the MNO A 115A, the number of users 120AA-NA who subscribe to each of the mobile services, the location of cell towers of the MNO A 115A, the mobile devices 220AA-NA supported by the MNO A 115A, the mobile technologies supported by the MNO A 115A, or generally any mobile specific data related to a mobile carrier. The service provider server 240 may track and store mobile attribute data of the MNO A 115A, such as by requiring the MNO A 115A to submit information in order to user the services provided by the service provider server 240. Alternatively or in addition the service provider server 240 may request the mobile specific attributes directly from the MNO A gateway server 215A. After identifying the mobile specific attributes of the MNO A 115A the system 100 may move to block 560.

If at block 530 the service provider server 240 determines that there is a sufficient quantity of data in the mobile specific attributes of the revenue generator A 110A to generate useful query suggestions the system 100 may move to block 560. At block 560 the service provider server 560 may retrieve queries related to the query selected by the revenue generator A 110A and the mobile specific attributes of the revenue generator A 110A and/or of the mobile carrier A 115A. For example, the service provider server 240 may communicate the mobile specific attributes and the selected query to an existing query suggestion system 350, and the query suggestion system 350 may return one or more related queries. Alternatively or in addition the service provider server 240 may combine the query selected by the revenue generator A 110A with one or more of the mobile specific attributes to create query suggestions. For example if one of the selected queries of the revenue generator A 110A is “Britney Spears” and a mobile attribute of the mobile carrier A 115A is that the mobile carrier provides users 120AA-NA a ringback tone service, the service provider server may suggest the query “Britney Spears ringback tones” to the revenue generator A 110A. The users 120AA-NN on the MNO A 115A may be interested in “Britney Spears ringback tones,” because the MNO A 115A provides a ringback tone service. At block 570 the service provider server 240 may provide the suggested queries to the revenue generator A 110A. The revenue generator A 110A may then target one or more listings or campaigns to the one or more of the suggested queries.

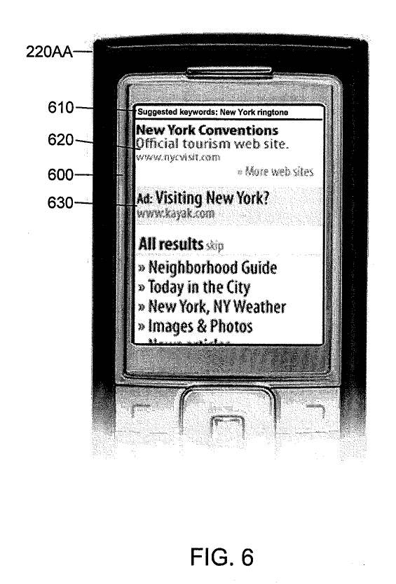

FIG. 6 illustrates a mobile device 220AA displaying queries suggested to a user in the system of FIG. 1 or other systems for suggesting keywords based on mobile specific attributes. The mobile device 220AA may include a screen 600, suggested queries 610, a search result 620 and an advertisement 630. The screen 600 may be displayed to a user AA 120AA after the user AA 120AA searches for “New York” though a mobile search portal. If a mobile specific attribute of the user AA 120AA is that the user AA 120AA subscribes to a ringtone service, the service provider server 240 may suggest the query “New York ringtones” to the user AA 120AA. If the user AA 120AA were to click on the suggested query the service provider server 240 may provide the user AA 120AA with a search result 620 related to a “New York ringtone,” such as a ringtone for the song “New York, New York.” Since the user AA 120AA is interested in New York, and since the user AA 120AA subscribes to a ringtone service, the user AA 120AA may be interested in a “New York ringtone.”

FIG. 7 illustrates a general computer system 700, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 700 may include a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 712 configured to allow a user to interact with any of the components of system 700. The input device 712 may be a number pad, a keyboard, or a cursor control device, such as a mouse, or a joystick, touch screen display, remote control or any other device operative to interact with the system 700.

The computer system 700 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the computer system 700. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 235 may communicate voice, video, audio, images or any other data over the network 235. The instructions 724 may be implemented with hardware, software and/or firmware, or any combination thereof. Further, the instructions 724 may be transmitted or received over the network 235 via a communication interface 718. The communication interface 718 may be a part of the processor 702 or may be a separate component. The communication interface 718 may be created in software or may be a physical connection in hardware. The communication interface 718 may be configured to connect with a network 235, external media, the display 714, or any other components in system 700, or combinations thereof. The connection with the network 235 may be a physical connection, such as a wired Ethernet connection or may be established wirelessly as discussed below. Likewise, the additional connections with other components of the system 700 may be physical connections or may be established wirelessly. In the case of a service provider server 240, a third party server 250, an advertising services server 260, the servers may communicate with users 120AA-NN and the revenue generators 110A-N through the communication interface 718.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of suggesting a mobile query based on a mobile specific attribute and a search query, comprising:
receiving a search query from a user on a mobile device, wherein the mobile device is associated with a mobile carrier;
identifying a mobile specific attribute of the user;
generating a suggested query related to the mobile specific attribute of the user and the search query; and
providing the suggested query to the user.

2. The method of claim 1 wherein generating a suggested query related to the mobile specific attribute of the user and the search query further comprises:
submitting the mobile specific attribute of the user and the search query to a query suggestion system;
processing the mobile specific attribute of the user and the search query by the query suggestion system to generate the suggested query; and
retrieving the suggested query from the query suggestion system.

3. The method of claim 2 wherein processing of the mobile specific attribute of the user and the search query further comprises combining the mobile specific attribute of the user and the search query.

4. The method of claim 1 wherein providing the suggested query to the user further comprises causing the suggested query to be displayed on the mobile device of the user.

5. The method of claim 4 further comprising providing a mobile search result to the user when the user clicks on the suggested query.

6. The method of claim 1 wherein the mobile specific attribute of the user comprises at least one of an amount of time the user uses the mobile device to access a mobile web each month, an amount of time the user spends talking on the mobile device each month, a cost of a mobile service plan of the user, a feature of the mobile service plan of the user, a list of mobile web sites visited by the user, an amount of data the user receives per month, a mobile specific purchase history of the user, a number of text messages sent by the user, a number of text messages received by the user, a browsing history of mobile specific sites of the user, and a characteristic of the mobile device of the user.

7. The method of claim 1 further comprising identifying a mobile specific attribute of the mobile carrier and generating the suggested query related to the mobile specific attribute of the mobile carrier and the search query.

8. The method of claim 7 wherein the mobile specific attribute of the mobile carrier comprises at least one of a mobile service provided by the mobile carrier, a number of users who subscribe to the mobile service, a geographic location of one or more cell phone towers utilized by the mobile carrier, a mobile device supported by the mobile carrier, and a mobile technology supported by the mobile carrier.

9. A method of suggesting an query to a revenue generator based on a targeted query and a mobile specific attribute, comprising:
providing an interface enabling a revenue generator to target an advertisement to a query and a mobile carrier;
determining a mobile specific attribute of the revenue generator;
generating a suggested query related to the mobile specific attribute of the revenue generator and the targeted query; and
providing the suggested query to the revenue generator.

10. The method of claim 9 wherein retrieving a query related to the mobile specific attribute of the revenue generator and the targeted query further comprises:
submitting the mobile specific attribute of the revenue generator and the targeted query to a query suggestion system;
processing the mobile specific attribute of the revenue generator and the targeted query by the query suggestion system to generate a suggested query; and
retrieving the suggested query from the from the query suggestion system.

11. The method of claim 10 wherein processing of the mobile specific attribute of the revenue generator and the targeted query further comprises combining the mobile specific attribute of the revenue generator and the targeted query.

12. The method of claim 9 wherein providing the suggested query to the revenue generator further comprises causing the suggested query to be displayed via the interface to the revenue generator.

13. The method of claim 12 further comprising allowing the revenue generator to target the advertisement to the suggested query and the mobile carrier.

14. The method of claim 9 wherein the mobile specific attribute of the revenue generator comprises at least one of an extent of a mobile presence of the revenue generator, a content of a mobile site of the revenue generator, a mobile service offered by the revenue generator, and an item offered for sale by the revenue generator, wherein the item functions with a mobile device.

15. The method of claim 9 further comprising identifying a mobile specific attribute of the mobile carrier and generating the suggested query related to the mobile specific attribute of the mobile carrier and the search query.

16. The method of claim 15 wherein the mobile specific attribute of the mobile carrier comprises at least one of a mobile service provided by the mobile carrier, a number of users who subscribe to the mobile service, a geographic location of one or more cell phone towers utilized by the mobile carrier, a mobile device supported by the mobile carrier, and a mobile technology supported by the mobile carrier.

17. A system for suggesting a mobile query to a user based on a mobile specific attribute and a search query, comprising:
a memory to store a search query;
an interface operatively connected to the memory to communicate with a user on a mobile device, wherein the mobile device is associated with a mobile carrier; and
a processor operatively connected to the memory and the interface the processor for running instructions, wherein the processor receives the search query from the user via the interface, identifies a mobile specific attribute of the user, generates a suggested query related to the mobile specific attribute of the user and the search query, and provides the suggested query to the user.

18. The system of claim 17 wherein the processor is further operative to combine the search query and the mobile specific attribute of the user to generate the suggested query.

19. The system of claim 17 wherein the processor is further operative to add the suggested query to a mobile page and communicate the mobile web page to the mobile device of the user via the interface.

20. The system of claim 19 wherein the processor is further operative to provide a mobile search result to the mobile device of the user when the user clicks on the suggested query on the mobile page.
